(19) United States
(12) Patent Application Publication
(10) Pub. No.: US 2009/0015811 A1
(43) Pub. Date: Jan. 15, 2009

(54) EXPOSURE APPARATUS, METHOD FOR SELECTING OPTICAL ELEMENT, AND DEVICE MANUFACTURING METHOD

(75) Inventor: Tomoaki Kawakami, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/170,377

(22) Filed: Jul. 9, 2008

(30) Foreign Application Priority Data
Jul. 11, 2007 (JP) 2007-182444

(51) Int. Cl. G03B 27/54

(52) U.S. Cl. 355/67

(57) ABSTRACT

An exposure apparatus includes a light source configured to generate light having a wavelength of 250 nm or less, an illumination optical system comprising an optical element having synthetic quartz as a lens material and configured to illuminate an original plate using the light generated by the light source, and a projection optical system configured to project a pattern of the original plate onto a substrate. A value of an absorption coefficient of a hydroxyl group of the optical element having an infrared absorption band at 3585 cm⁻¹ is within a range which is determined depending on a wavelength of the light generated by the light source.

### BACKGROUND OF THE INVENTION

1. Field of the Invention

The present invention generally relates to an exposure apparatus, a method for selecting an optical element, and a device manufacturing method.

2. Description of the Related Art

In recent years, a light source of a wavelength of 250 nm or less is used in an exposure apparatus. The light source of a wavelength of 250 nm or less is, for example, a krypton fluoride (KrF) excimer laser of a 248 nm wavelength or argon fluoride (ArF) excimer laser of a 193 nm wavelength.

Generally, light transmissivity of an optical element such as a lens depends on a wavelength of incident light. For high efficient exposure, a material (lens material) having high light transmissivity is selected for an optical element which is used in an optical system of an exposure apparatus. If a laser having a wavelength of 250 nm or less is used as the light source, synthetic quartz or fluorite is used as the lens material of the optical element. The synthetic quartz has advantages over fluorite because of its strong mechanical strength, moderate price, and high processability for a diffractive optical element compared to the fluorite.

Since these laser light sources emit linear polarized light, if the substrate is illuminated with unpolarized light, a function to convert polarized light into unpolarized light is required in an illumination optical system of the exposure apparatus. Further, if polarized illumination is performed, an illumination optical system having a function to control linear polarized light emitted from a light source into a predetermined polarization state is necessary.

Thus, regardless of whether the light which illuminates the substrate is polarized light, an optical element of the illumination optical system which is capable of controlling a polarization state is necessary for the exposure apparatus and synthetic quartz is used as the lens material of the optical element.

However, there are various synthetic quartz having different properties. Accordingly, not all synthetic quartz is durable as the optical element used in the illumination optical system of the exposure apparatus. In other words, properties of some optical elements made of synthetic quartz degrade when exposed to light emitted from the above-described light source for a long time.

Under such circumstances, International Publication No. WO 2005/005694 discusses a method for determining durability of synthetic quartz as a lens material and selecting the synthetic quartz which contains less impurities. A degree of impurities is classified, for example, by a density of undesired matter such as Al or Na or by an absorption coefficient value (hereinafter referred to as α value) of an infrared absorption band at 3585 cm⁻¹ which is dependent on hydroxyl group as an impurity according to JIS C6704.

If an optical element including synthetic quartz having low durability is used as a lens material for exposure processing of the substrate for a long time, the optical element blackens and its transmissivity lowers or its birefringence changes, which results in degraded optical performance of the exposure apparatus. Thus, International Publication No. WO2005/005694 defines only the upper limit of the absorption coefficient of an infrared absorption band of a hydroxyl group and uses a lens material that satisfies such requirements regardless of a wavelength of the light source.

### SUMMARY OF THE INVENTION

The present invention is directed to an exposure apparatus having an optical element including synthetic quartz as a lens material capable of reducing degradation of optical performance for a long time and a method for selecting the optical element.

According to an aspect of the present invention, an exposure apparatus includes a light source configured to generate light having a wavelength of 250 nm or less, an illumination optical system comprising an optical element having synthetic quartz as a lens material and configured to illuminate an original plate using the light generated by the light source, and a projection optical system configured to project an image of a pattern of the original plate onto a substrate. A value of an absorption coefficient of a hydroxyl group of the optical element having an infrared absorption band at 3585 cm⁻¹ is within a range which is determined depending on a wavelength of the light generated by the light source.

According to another aspect of the present invention, a method is used that selects as an optical system one of a KrF optical system which is irradiated with KrF excimer laser light and an ArF optical system which is irradiated with ArF excimer laser light, an optical element having synthetic quartz as lens material is to be used. If a value of an absorption coefficient of a hydroxyl group of the optical element having an infrared absorption band at 3585 cm⁻¹ is within a range of 0.020 cm⁻¹ or more but not exceeding 0.100 cm⁻¹, the optical element is selected as available for both the KrF optical system and the ArF optical system. If a value of the absorption coefficient of the optical element is greater than 0.100 cm⁻¹ but not exceeding 0.400 cm⁻¹, the optical element is selected as available for the KrF optical system.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the present invention.

FIG. 1 illustrates a configuration of an exposure apparatus according to an exemplary embodiment of the present invention.

FIG. 2 illustrates a relation between transmissivity and the number of times of irradiation when synthetic quartz having different α values is continuously irradiated with ArF excimer laser.

FIGS. 3A and 3B illustrate a depolarization unit.

FIG. 4 illustrates a relation between a crystal axis of the depolarization unit and an optical axis of incident light, a polarization state of the incident light, and a polarization state of exiting light.

FIG. 5A illustrates an angle of a wedge shape of the depolarization plate. FIG. 5B illustrates a polarization state of light which passed through the depolarization plate in a plane perpendicular to the optical axis.

FIG. 6 illustrates a depolarization plate and a half-wavelength plate which can be switched alternately.

### DETAILED DESCRIPTION OF THE EMBODIMENTS

Various exemplary embodiments, features, and aspects of the invention will be described in detail below with reference to the drawings.

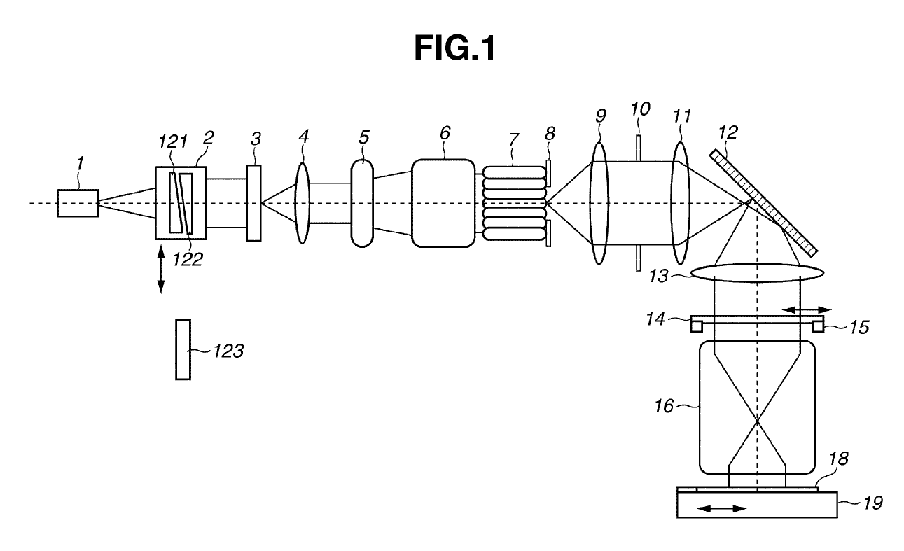

FIG. 1 illustrates a configuration of an exposure apparatus according to an exemplary embodiment of the present invention.

The exposure apparatus includes illumination optical systems (2 to 13 and 121 to 123) configured to illuminate a mask 14 which is an original plate by a light source 1 having a wavelength of 250 nm or less and a projection optical system 16 configured to project and expose the pattern of the mask 14 onto a wafer 18 which is a substrate.

The illumination optical system includes an optical element having an absorption coefficient value of a hydroxyl group having an infrared absorption band at 3585 cm⁻¹ within a predetermined range which is determined depending on a wavelength of the light source 1.

The light source 1 is, for example, a KrF excimer laser of a 248 nm wavelength or an ArF excimer laser of a 193 nm wavelength.

The light generated from the light source 1 is converted into a light flux having a predetermined shape by a light flux shaping optical system 2 and incident on a diffractive optical element 3.

When parallel light is incident on the diffractive optical element 3, a predetermined distribution is formed on a Fourier transform plane of the diffractive optical element. The light emitted from the diffractive optical element 3 is Fourier transformed by a Fourier transform lens 4. The diffractive optical element 3 is switchable depending on an effective light source to be formed. The effective light source refers to an angle distribution of light irradiated onto a surface of the mask 14. The effective light source is also equivalent to light intensity distribution on a pupil plane of the illumination optical system.

The light which is Fourier transformed by the Fourier transform lens 4 is converted into a shape such as an annular shape by an illumination light modification lens 5. As in the diffractive optical element 3, the illumination light modification lens 5 is switchable depending on the effective light source to be formed.

A condenser zoom lens 6 passes the light emitted from the illumination light modification lens 5 forms an image on an incidence surface of a fly-eye lens 7 at a predetermined magnification. The condenser zoom lens 6 and the fly-eye lens 7 are substantially in a conjugated relationship. Further, if the condenser zoom lens 6 is a magnification-changeable zoom lens, a light flux area of the incident light on the fly-eye lens 7 can be adjusted. Then, a plurality of illumination conditions can be set.

The fly-eye lens 7 includes a plurality of micro lenses which are arranged two-dimensionally. A vicinity of an exit surface of the fly-eye lens 7 serves as a pupil plane of the illumination optical system.

The diaphragm member 8 is disposed on the pupil plane to block passage of superfluous light so that a predetermined light distribution can be achieved. A size and a shape of an aperture of the diaphragm member 8 can be changed by a diaphragm drive mechanism (not shown).

An illumination lens 9 superimposes light emitted from the effective light source which is formed on the vicinity of the exit surface of the fly-eye lens 7 onto a field stop 10. The field stop 10 includes a plurality of movable light-shielding plates which can form a desired aperture shape so that an exposure area on the irradiation face of the mask 14 can be limited. This contributes to limiting an exposure area on the irradiation surface of the wafer 18 which is a substrate.

Imaging lenses 11 and 13 transfer the aperture shape of the field stop 10 onto the mask 14 which is arranged on an illumination target surface via a deflecting mirror 12. The mask 14 is held by a mask stage 15 and controlled by a control unit (not shown).

The projection optical system 16 is an optical system configured to project a circuit pattern of the mask 14 onto the wafer 18 with reduced size. The wafer 18 is set on an image plane of the projection optical system 16. The circuit pattern of the mask 14 is projected and transferred to the wafer 18 set on the image plane.

A wafer stage 19 holds the wafer 18. The wafer stage 19 is controlled by a control unit (not shown) and moves two-dimensionally in the optical axis direction of the projection optical system 16 and also along a plane perpendicular to the optical axis. During exposure, the mask stage 15 and the wafer stage 19 are driven in synchronization with each other in the direction of the arrow in FIG. 1 to perform scanning and exposing.

The exposure apparatus illustrated in FIG. 1 may include a depolarization element or a half-wavelength plate having synthetic quartz as the lens material. The wafer 18 may be illuminated by unpolarized light or polarized light using the depolarization element or the half-wavelength plate.

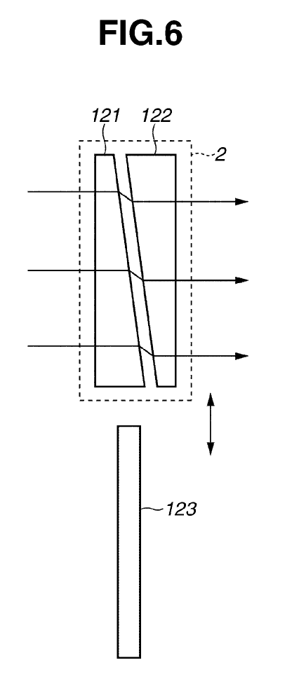

According to the present exemplary embodiment, if the wafer 18 is to be exposed with unpolarized light (unpolarized illumination), linear polarized light emitted from the light source 1 is converted into unpolarized light by an optical element of the light flux shaping optical system 2. The lens material of the optical element is made of synthetic quartz. In this case, for example, a depolarization plate 121 and a transparent wedge 122 having synthetic quartz as a lens material are disposed in the light flux shaping optical system 2 as illustrated in FIGS. 1 and 6.

Further, if the wafer 18 is exposed with polarized light (polarized illumination), a phase plate 123 having synthetic quartz as a lens material is arranged in the light flux shaping optical system 2 to adjust a oscillating direction of the polarized light. The phase plate 123 may be, for example, a half-wavelength plate. To enable switching between polarized illumination and unpolarized illumination, the light flux shaping optical system 2 may be configured such that the depolarization plate 121 or the depolarization plate 121 and the transparent wedge 122 can be replaced with the phase plate 123.

Since the light emitted from the light source 1 is directly incident on the light flux shaping optical system 2, generally an energy density on the surface of the optical element of the light flux shaping optical system 2 is high. Accordingly, a lens material as an optical material has high durability. Thus, an optical element using synthetic quartz as lens material and irradiated with light from the light source 1 for a long time would show little degradation of property (e.g., transmissivity).

An absorption coefficient value (α value) of a hydroxyl group having an infrared absorption band at 3585 cm⁻¹ according to the synthetic quartz used in the phase plate 123 is set as follows. If the light source 1 is a KrF excimer laser, synthetic quartz having the α value of 0.020 cm⁻¹ or more but not exceeding 0.400 cm⁻¹ is used.

On the other hand, if the light source 1 is an ArF excimer laser, synthetic quartz having the α value of 0.020 cm⁻¹ or more but not exceeding 0.100 cm⁻¹ is used. By using synthetic quartz which is selected according to a wavelength of the light source 1, high durability against laser can be achieved. Here, α value can be obtained from the intensity of incident light and intensity of transmitted light when light is incident on the lens material.

The above-described absorption coefficient (α value) will be described in detail. The impurities in synthetic quartz are, for example, hydroxyl group, Al, Na, and Li. The hydroxyl group makes up for a defect center in relation with impurities that substitutes for Si or exists as a H2O molecule included in the crystal.

Since the hydroxyl group includes a certain number of absorption bands near 3000 cm⁻¹, there is a close relation between an amount of light absorbed by the hydroxyl group and quality of synthetic quartz. If the amount of absorbed light due to the hydroxyl group is large, then many hydroxyl groups are included in the synthetic quartz as the impurities. If the amount of absorbed light due to the hydroxyl group is small, then a number of hydroxyl groups as the impurities included in the synthetic quartz is small. Thus, it may be assumed that if the α value is large, then durability is low whereas if the α value is small, durability is high. However, as described below, this is not always the case.

Thus, an experiment was performed to clarify a relationship between transmissivity, durability, and grade such as absorption coefficient, of synthetic quartz and light source. This experiment focused on the absorption coefficient (α value) of a hydroxyl group in synthetic quartz having an infrared absorption band at 3585 cm⁻¹ as an index to determine a quality of the synthetic quartz.

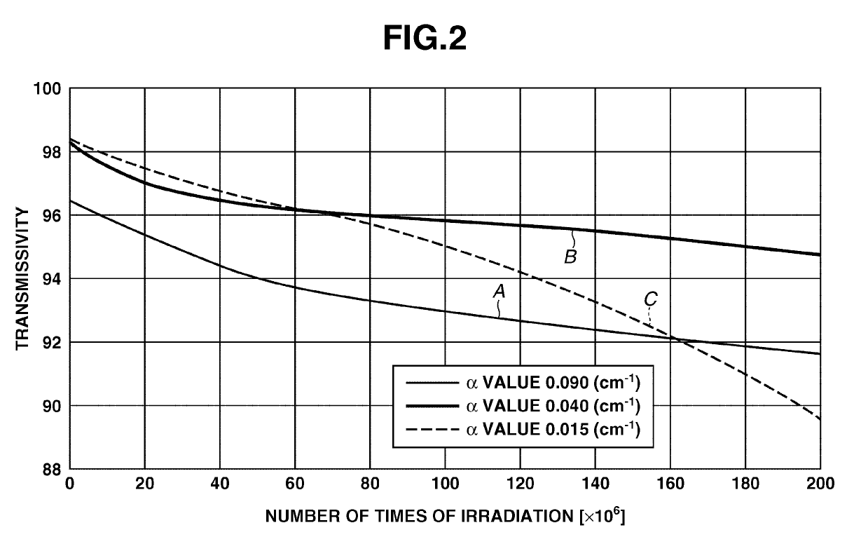

In this experiment, several types of synthetic quartz having different α values were continuously irradiated with ArF excimer laser or KrF excimer laser. The experiment was performed for a plurality of times. A part of the experimental results is illustrated in FIG. 2.

FIG. 2 illustrates a relation between a number of times of irradiation (pulse number) and transmissivity of synthetic quartz A having an α value of 0.09 cm⁻¹, synthetic quartz B having an α value of 0.04 cm⁻¹, and synthetic quartz C having an α value of 0.015 cm⁻¹ when the synthetic quartz is irradiated with ArF excimer laser. Although transmissivity of the synthetic quartz A was reduced 2% soon after the irradiation was started, reduction in transmissivity was moderate after then and a sharp reduction in transmissivity was not observed even after 200×10⁶ times of irradiation. The transmissivity of the synthetic quartz B showed a small drop of 0.7% soon after the irradiation was started and a sharp reduction in transmissivity was not observed even when its was irradiated for a long time.

Although transmissivity of the synthetic quartz C having a smaller α value than the synthetic quartz A and B showed a small drop soon after the irradiation was started, after about 100×10⁶ times of irradiation, the transmissivity showed a sharp reduction. The 200×10⁶ times of irradiation according to this experiment would correspond to several years of typical usage of an actual exposure apparatus.

Thus, as seen from the result of the experiment, when ArF excimer laser is used as the light source of the exposure apparatus, the synthetic quartz A and B are appropriate for use as a lens material of the optical element of the exposure apparatus (i.e. an illumination optical system or a projection optical system), however, the synthetic quartz C is not appropriate.

Further, by repeating similar experiment described above on synthetic quartz having α values different from the α values of the synthetic quartz A through C, it was understood that if the synthetic quartz has an α value within a range of 0.020 cm⁻¹ or more but not exceeding 0.100 cm⁻¹, then the synthetic quartz is appropriate for the use in ArF excimer laser. Further, by repeating similar experiments described above using KrF excimer laser as the light source, it was found that if the α value of the synthetic quartz is within a range of 0.020 cm⁻¹ or more but not exceeding 0.400 cm⁻¹, the synthetic quartz is appropriate for KrF excimer laser.

As the light source, KrF excimer laser can have wider allowable range of the α value than ArF excimer laser. Thus, it is understood that the allowable range of the α value depends on the wavelength of the light source. In other words, degree of degradation of transmissivity and durability of synthetic quartz when exposure is performed for a long time depends on a wavelength of the light source.

Further, if a value of an infrared absorption coefficient of a hydroxyl group having the infrared absorption band at 3585 cm⁻¹ is within a predetermined range with upper and lower limits as described above, transmissivity does not drop sharply and high durability is maintained.

However, if the value of the absorption coefficient is smaller than a predetermined value like the synthetic quartz C, transmissivity is greatly reduced when it is used for a long time and durability becomes low. Thus, high durability is not always achieved even when the α value is small.

Accordingly, when exposure is carried out with a light source using shorter wavelength such as 250 nm or less, by arranging the α value of the synthetic quartz within a predetermined range having the lower limit above zero as described above, high transmissivity of an optical element using synthetic quartz can be maintained for a long time.

In this way, synthetic quartz which is appropriate for use in an exposure apparatus can be selected depending on a type of the light source and the selected synthetic quartz can be used as the lens material of the optical element of the illumination optical system. For example, an optical element using synthetic quartz as lens material can be selected depending on the two optical systems, namely a KrF optical system which is irradiated with KrF excimer laser or an ArF optical system which is irradiated with ArF excimer laser.

If an absorption coefficient value of a hydroxyl group of an optical element having infrared absorption band at 3585 cm⁻¹ is 0.020 cm⁻¹ or more but not exceeding 0.100 cm⁻¹ as described above, the optical element is selected as appropriate for both the KrF optical system and the ArF optical system. If the absorption coefficient value of the optical element exceeds 0.100 cm⁻¹ but does not exceed 0.400 cm⁻¹, then the optical element is selected as appropriate for the KrF optical system.

Since synthetic quartz has strong birefringence properties, the synthetic quartz is effectively used in a unit which makes positive use of birefringence. For example, the synthetic quartz is effectively used in a depolarization unit or an optical integrator. A case where the synthetic quartz is used as a lens material of the depolarization unit is described below.

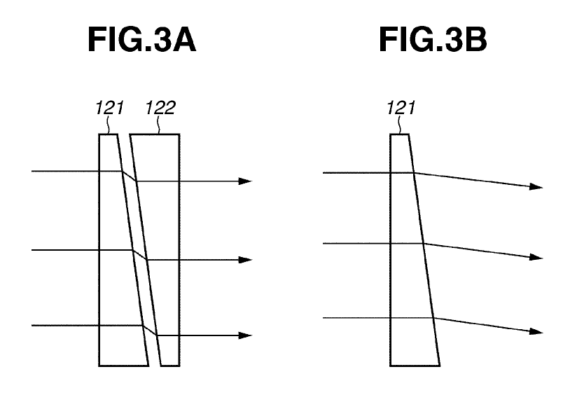

In unpolarized illumination, a depolarization unit (depolarizer) such as a unit illustrated in FIG. 3A is used. The depolarization unit includes the depolarization plate 121 and the transparent wedge 122. A cross section of the depolarization plate 121 including the optical axis is wedge-shaped. The transparent wedge 122 is arranged so that it has a wedge shape inverse to the depolarization plate 121.

The transparent wedge 122 is an auxiliary element configured to correct a direction of the polarized exit light from the depolarization plate 121 in a same direction as the incident direction. Wedge angles of the transparent wedge 122 and the depolarization plate 121 are slightly different according to the difference in the refractive index of the elements. If the exit direction is allowed to be different from the incident direction, then the transparent wedge 122 is not necessarily used.

FIG. 3B is a cross section of a depolarization unit without the transparent wedge 122 illustrated in FIG. 3A. The depolarization plate 121 uses synthetic quartz as its lens material. As described above, the absorption coefficient of the synthetic quartz is within a range of the absorption coefficient which is determined by the wavelength of the light source 1.

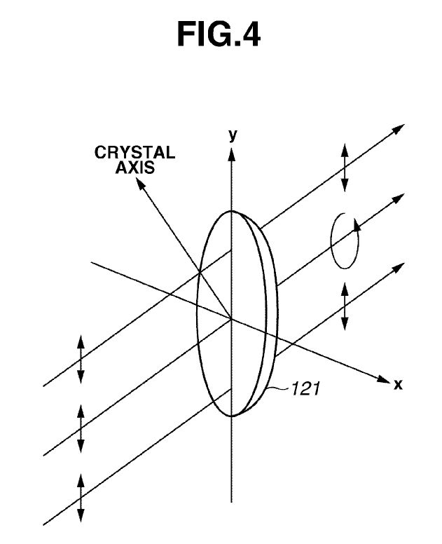

Further, as illustrated in FIG. 4, a crystal axis of the depolarization plate 121 is arranged so as not to match a main polarization direction of the incident light flux. According to the present exemplary embodiment, the crystal axis is exemplarily arranged at an angle of 45 degrees with respect to the main polarization direction of the light flux.

FIG. 4 is a perspective view of the depolarization plate 121 in FIG. 3A illustrating its configuration. As illustrated in FIG. 4, the direction of the crystal axis of the depolarization plate 121 is at an angle of 45 degrees with respect to the polarization direction (Y direction) of the linear polarized light emitted from the light source 1.

The thickness of the depolarization plate 121 is designed so that a light ray (more particularly linear polarized light in the Y direction) that passes the center position of the depolarization plate 121, through which the optical axis passes, is converted into a circular polarization. However, the light ray that passes the center of the depolarization plate 121 is not necessarily converted into the circular polarization. Furthermore, the polarization direction (Y direction) of the linear polarized light emitted from the light source and the wedge direction of the depolarization plate 121 do not need to match with each other.

A polarization state of the light flux incident on the depolarization plate 121 is changed continuously or in steps in a certain direction so that the entire light flux is depolarized to a substantially non-polarization state. In order to increase the amount of relative phase change in the exiting light flux, if a diameter of the incident light flux is not symmetrical, the wedge direction of the depolarization plate 121 may be set to match the direction of the maximum diameter.

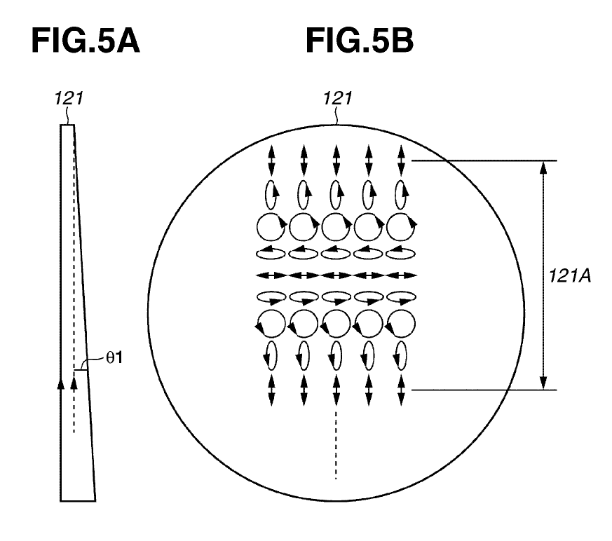

FIGS. 5A and 5B illustrate a function of the depolarization plate 121 illustrated in FIG. 3A. According to the present exemplary embodiment, the polarization state of the light flux which exits the depolarization plate 121 changes in the vertical direction (Y direction) as illustrated in FIG. 5B.

According to the present exemplary embodiment, the wedge direction (inclination direction) of the depolarization plate 121 matches the polarization direction of the linear polarized light emitted from the light source.

Within a range 121A in FIG. 5B, the polarization state continuously changes from top to bottom as follows, linear polarized light in Y direction, counterclockwise ellipse polarization, counterclockwise circular polarization, counterclockwise ellipse polarization, linear polarized light in X direction, clockwise ellipse polarization, clockwise circular polarization, clockwise ellipse polarization, and linear polarized light in Y direction. This change in polarization state is repeated in the range 121A in the Y direction.

The number of repetitions of the change in polarization state is determined depending on a wedge angle θ1 and a thickness of the depolarization plate 121 illustrated in FIG. 5A and a beam diameter of the light emitted from the light source. The wedge angle θ1 and the thickness can be determined depending on a degree of necessary depolarization. In order to obtain a sufficient depolarization effect, the polarization state may be repeated 5 times or more.

When performing X polarization exposure or Y polarization exposure using the exposure apparatus illustrated in FIG. 1, X polarization or Y polarization is performed by the light flux shaping optical system 2 using the above-described phase plate 123.

The phase plate 123 illustrated in FIGS. 1 and 6 includes a half-wavelength plate which is made of a single crystal synthetic quartz. The crystal optical axis of the half-wavelength plate is rotatable about the optical axis.

The value of the absorption coefficient of the synthetic quartz used in the phase plate 123 is within the above-described predetermined range. Further, the phase plate 123 is not limited to a half-wavelength plate and a quarter-wavelength plate may be used.

The light emitted from the light source 1 typically has a degree of polarization of 95% or more. Thus, substantially linear polarized light is incident on the phase plate 123. If the degree of polarization of the light emitted from the light source 1 is low, an optical element which exclusively transmits specific polarized light may be arranged upstream of the phase plate 123.

If the crystal optical axis of the phase plate 123 is set at an angle of 0 degree or 90 degrees with respect to the polarization plane of the incident linear polarized light, the linear polarized light incident on the phase plate 123 passes through the phase plate 123 as it is without changing the polarization plane.

Further, if the crystal optical axis of the phase plate 123 is set at an angle of 45 degrees with respect to the polarization plane of the incident linear polarization light, the linear polarized light incident on the phase plate 123 is converted into linear polarized light having the polarization plane changed by 90 degrees.

If Y-polarized light is incident on the phase plate 123, the phase plate 123 is set so that the crystal optical axis of the phase plate 123 is at an angle of 0 degree or 90 degrees with respect to the polarization plane of the incident Y-polarized light. In this case, the Y-polarized light incident on the phase plate 123 passes through the phase plate 123 as it is without changing the polarization plane and illuminates the mask 14 in the state of the Y-polarized light.

On the other hand, if the crystal optical axis of the phase plate 123 is set at an angle of 45 degrees with respect to the polarization plane of the incident light, the polarization plane of the Y-polarized light incident on the phase plate 123 changes 90 degrees and the Y-polarized light is converted into X-polarized light and illuminates the mask 14 in the state of the X-polarized light.

Synthetic quartz is used as the lens material of the phase plate 123 for performing the polarization illumination. If the light source 1 is a KrF excimer laser, synthetic quartz having an α value of 0.020 cm⁻¹ or more but not exceeding 0.400 cm⁻¹ will be used. If the light source 1 is an ArF excimer laser, synthetic quartz having an α value of 0.020 cm⁻¹ or more but not exceeding 0.100 cm⁻¹ is used.

By using synthetic quartz which is selected according to its α value, high durability can be obtained even if the synthetic quartz is used for polarized illumination.

Next, a manufacturing method of a device (e.g. a semiconductor IC element, a liquid crystal display element) using the above-described exposure apparatus is described. The device is manufactured via an exposure process, a developing process, and other known processes using the exposure apparatus according to the above-described exemplary embodiment. A substrate (such as a wafer or a glass substrate) on which a photosensitive material is coated is exposed to light in the exposure process. The substrate or the photosensitive material is developed in the developing process. The other known processes are etching, resist stripping, dicing, bonding, and packaging. A high-quality device can be manufactured according to the device manufacturing method of the present invention.

While the present invention has been described with reference to exemplary embodiments, it is to be understood that the present invention is not limited to the disclosed exemplary embodiments. The scope of the following claims is to be accorded the broadest interpretation so as to encompass all modifications, equivalent structures, and functions.

This application claims priority from Japanese Patent Application No. 2007-182444 filed Jul. 11, 2007, which is hereby incorporated by reference herein in its entirety.

What is claimed is:

1. An exposure apparatus comprising:
a light source configured to generate light having a wavelength of 250 nm or less;
an illumination optical system comprising an optical element having synthetic quartz as a lens material and configured to illuminate an original plate using the light generated by the light source; and
a projection optical system configured to project an image of a pattern of the original plate onto a substrate;
wherein a value of an absorption coefficient of a hydroxyl group of the optical element having an infrared absorption band at 3585 cm⁻¹ is within a range which is determined depending on a wavelength of the light generated by the light source.

2. The exposure apparatus according to claim 1, wherein the light source is krypton fluoride excimer laser, and wherein a lower limit of the range is 0.020 cm⁻¹ and an upper limit of the range is 0.400 cm⁻¹.

3. The exposure apparatus according to claim 1, wherein the light source is argon fluoride excimer laser, and wherein a lower limit of the range is 0.020 cm⁻¹ and an upper limit of the range is 0.100 cm⁻¹.

4. The exposure apparatus according to claim 1, wherein the optical element is a depolarization element.

5. The exposure apparatus according to claim 1, wherein the optical element is a phase plate.

6. The exposure apparatus according to claim 1, wherein a value of a lower limit of the range is greater than zero.

7. A method for manufacturing a device comprising:
exposing a substrate to light using the exposure apparatus according to claim 1; and
developing the exposed substrate.

8. A method for selecting as an optical system one of a krypton fluoride optical system which is irradiated with krypton fluoride excimer laser light and an argon fluoride optical system which is irradiated with argon fluoride excimer laser light, the method using an optical element having synthetic quartz as lens material, the method comprising:
selecting the optical element as available for both the krypton fluoride optical system and the argon fluoride optical system if a value of an absorption coefficient of a hydroxyl group of the optical element having an infrared absorption band at 3585 cm⁻¹ is within a range of 0.020 cm⁻¹ or more but not exceeding 0.100 cm⁻¹, and
selecting the optical element as available for the krypton fluoride optical system if a value of the absorption coefficient of the optical element is greater than 0.100 cm⁻¹ but not exceeding 0.400 cm⁻¹.
